(19) United States
(12) Patent Application Publication
(10) Pub. No.: US 2016/0144492 A1
(43) Pub. Date: May 26, 2016

(54) TORQUE WRENCH

(71) Applicant: Zheng-Cong Jiang, Taichung City (TW)

(72) Inventor: Zheng-Cong Jiang, Taichung City (TW)

(21) Appl. No.: 14/553,992

(22) Filed: Nov. 25, 2014

(51) Int. Cl. B25B 23/142

(52) U.S. Cl. CPC B25B 23/1422

(57) ABSTRACT

A torque wrench includes a wrench body, a wrench head pivotally carried by the arm, a plunger, a pawl, a spring for urging the plunger, and an adjustment assembly. The adjustment assembly is operatively connected to the spring to vary an effective force of the spring on the plunger. The piezoelectric sensor is interposed in between the plunger and the spring for producing an output signal in response to the effective force exerted by the spring. A processor is provided for converting the output signal into an equivalent torque value, the equivalent torque value indicating a preset torque to be applied by the torque wrench to the workpiece. A display is further employed for displaying the equivalent torque value. Application of a torque greater than the preset torque to the workpiece causes the wrench head to pivot relative to the wrench body about a pivot joint.

### BACKGROUND OF THE INVENTION

1. Field of the Invention

The present invention relates to a torque wrench for applying a pre-determined amount of torque to a fastener, and is more particularly concerned with a torque wrench having means for precisely setting a preset torque for the wrench.

2. Description of the Related Art

Torque wrenches are well known in the art. They vary from simple mechanical types to sophisticated electronic types. There are several types of mechanical torque wrenches that are routinely used to tighten fasteners to specified torque levels.

One example of a mechanical torque wrench is illustrated in U.S. Pat. Nos. 5,435,190 or 6,463,834, which makes an audible click to let the user know when a preset torque level has been achieved and simultaneously provide a feeling of sudden torque release to the user. This torque wrench generally includes a hollow tube in which a spring and pawl mechanism is housed. The pawl is forced against one end of a bar that extends from a drive head. The bar and drive head are pivotally connected to the hollow tube about a pivot joint and rotate relative thereto once the preset torque level is exceeded. The preset torque level is selected by a user by causing the spring to exert either greater or lesser force on the pawl. The force acts on the bar through the pawl to resist rotation of the bar relative to the hollow tube. As the torque exerted on the fastener exceeds the preset torque value, the force tending to cause the bar to pivot relative to the hollow tube exceeds the force preventing its rotation and the pawl “trips.” When released by the action of the pawl, the bar pivots and hits the inside of the tube, thereby producing a click sound and a sudden torque release that is detectable by the user.

Typically, the preset torque values to assist the user in setting the torque wrench are permanently marked on a scale that is marked on the tube itself. That is, these torque wrenches have permanently marked gages that are read by the user when setting the preset torque value. However, these gages can be hard to read, especially when the user is occupied with torquing a fastener with smooth and continuous motion to achieve proper fastening Moreover, the size of the markings is often small and the resolution of the markings is often limited by the physical space available on the gage. Besides, calibration of the wrenches often requires disassembling the unit to replace worn out parts, which can be expensive and time consuming. And, calibration is often needed to correct the effect of the spring's characteristics and mechanical wear that occurs over time. Often, such wear cannot be compensated for without calibration since the gages are most often permanently printed on the handle.

### SUMMARY OF THE INVENTION

Accordingly, it is an object of the present invention to provide a torque wrench to satisfy the aforementioned need. In particular, no calibration will be needed to correct the effect of the spring's characteristics and mechanical wear that occurs over time.

The torque wrench includes an elongated, tubular wrench body, a wrench head pivotally carried by the wrench body, a plunger, a pawl, a spring, an adjustment assembly, a piezoelectric sensor, a processor within the wrench body, and a display outside the wrench body. The wrench head has a drive portion constructed to be removably engaged with a workpiece, and a bar extending from the drive portion into the front end of the wrench body. The wrench head and the wrench body are pivotally connected for pivotal movement relative to one another about a pivot joint. The plunger is slidably movable within the wrench body. The pawl is disposed between the bar and the plunger. The spring is mounted rearwardly of the plunger for urging the plunger and in turn the pawl against a rear end of the bar. The adjustment assembly is disposed in the rear end of the wrench body and operatively connected to the spring to vary an effective force of the spring on the plunger. The piezoelectric sensor is interposed in between the plunger and the spring for producing an output signal in response to the effective force exerted by the spring. The processor is configured for converting the output signal into an equivalent torque value which indicates a preset torque to be applied by the torque wrench to the workpiece. The display is provided for displaying the equivalent torque value. Application of a torque greater than the preset torque to the workpiece causes the wrench head to pivot relative to the wrench body about the pivot joint. A backing plate may be employed and interposed in between the piezoelectric sensor and the spring.

Preferably, the piezoelectric sensor is substantially flat. The plunger has a rear planar surface attached to a front planar surface of the piezoelectric sensor, and the backing plate has a front planar surface attached to a rear planar surface of the piezoelectric sensor. Alternatively, the backing plate may define in a front surface a recess to receive the piezoelectric sensor.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a perspective view of a torque wrench in accordance with a first embodiment of the present invention;

FIG. 2 is another perspective view of the structure shown in FIG. 1;

FIG. 3 is a perspective view of interior parts of the structure shown in FIG. 1, shown in a normal position;

FIG. 4 is view similar to FIG. 3, shown in an actuated position;

FIG. 5 is a partial enlarged view of the structure shown in FIG. 4;

FIG. 6 is a block diagram of the structure shown in FIG. 1; and

FIG. 7 is a partial enlarged view of a torque wrench in accordance with a second embodiment of the present invention.

### DETAILED DESCRIPTION OF EMBODIMENTS

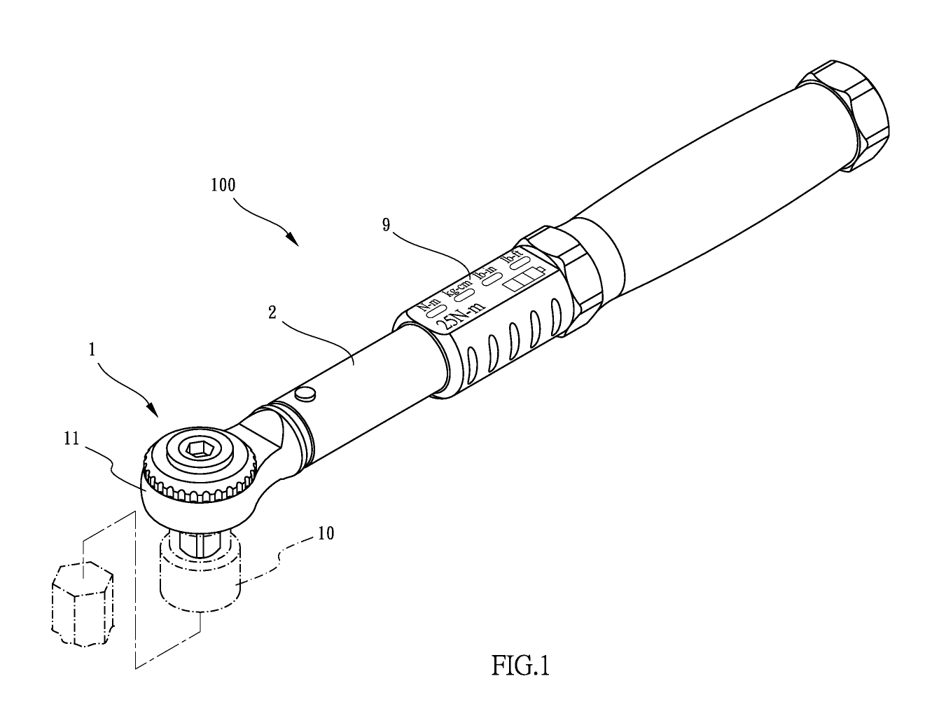

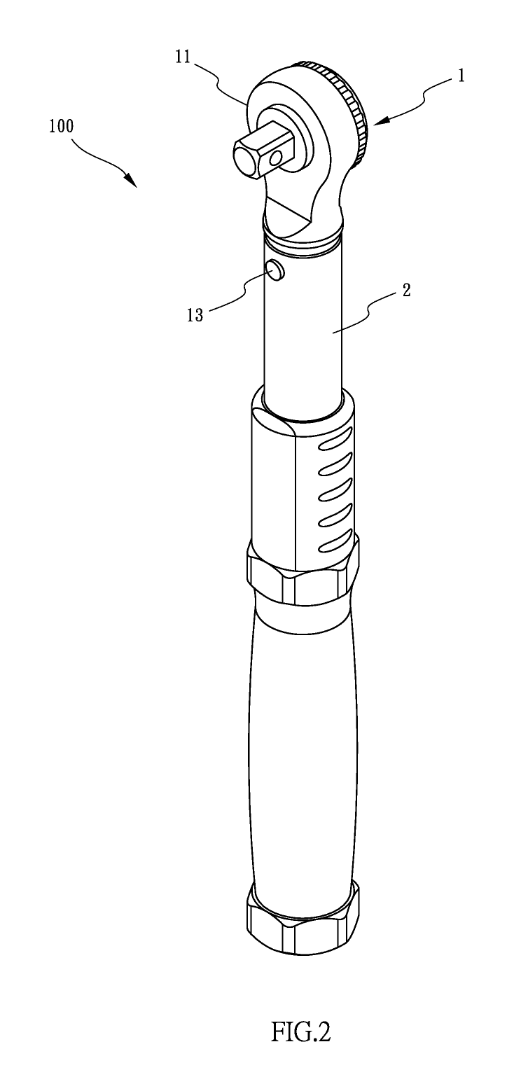

Referring now to the drawings for a more detailed description of the present invention and more particularly to FIGS. 1 and 2, a novel torque wrench made according thereto is generally indicated by the reference numeral 100. The torque wrench 100 as shown includes a wrench head 1, an elongated, tubular wrench body 2, parts within the tubular wrench body 2, and a display 9 on the wrench body 2 for indicating a preset torque to be applied by the torque wrench 100 to a workpiece 10.

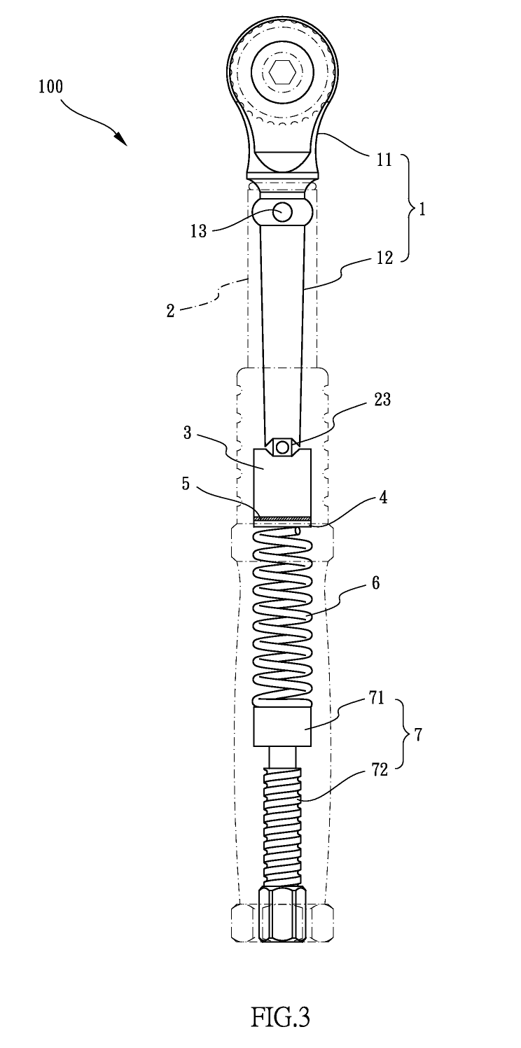

As shown in FIG. 3, the wrench head 1, such as a ratchet-type head, has a drive portion 11 and a bar 12 extending from the drive portion 11. The drive portion 11 is constructed to be removably engaged with the workpiece 10 (see FIG. 1). The bar 12 is inserted within a front end of the wrench body 2. The wrench head 11 and the wrench body 2 are pivotally connected by a pivot pin 13 for pivotal movement relative to one another.

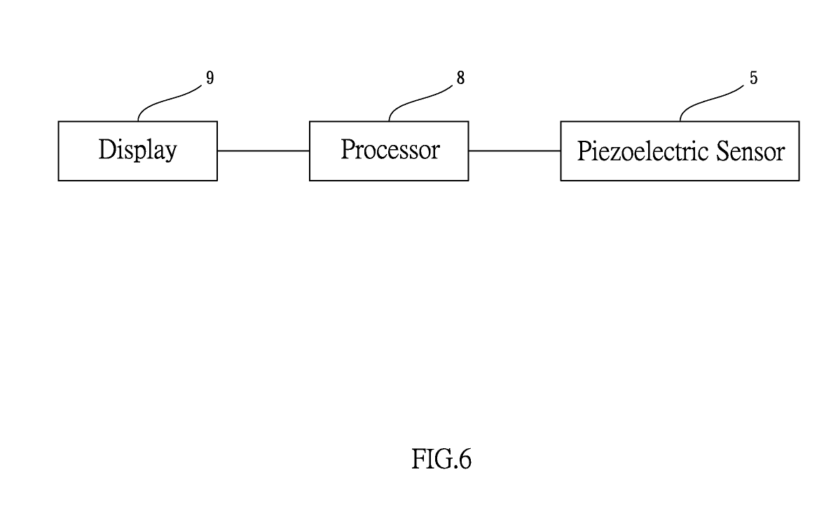

Within the wrench body 2 are a pawl 23, a plunger 3, a piezoelectric sensor 5, a backing plate 4, a coil spring 6 and an adjustment assembly 7 as well as a processor 8 (see FIG. 6). Specifically, the pawl 23 is interposed between the bar 12 of the wrench head 1 and the plunger 3. The plunger 3 is slidably movable within the wrench body 2. The coil spring 6 is mounted rearwardly of the plunger 3 for urging the plunger 3 and in turn the pawl 23 against a rear end of the bar 12. The adjustment assembly 7 is disposed in a rear end of the wrench body 2 and operatively connected to the coil spring 6 to vary an effective force of the coil spring 6 on the plunger 3.

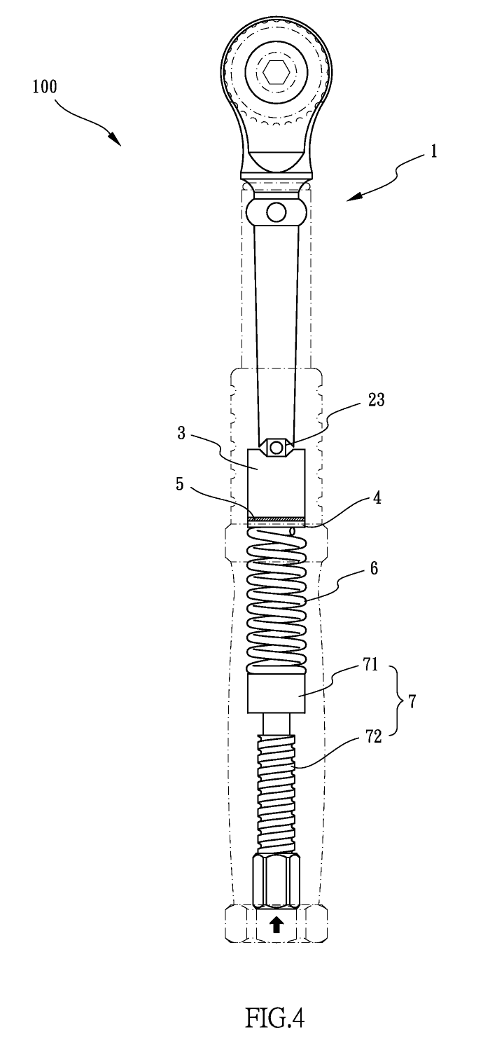

As shown in FIGS. 3 and 4, the plunger 3 is biased into engagement with the pawl 23 by means of the coil spring 6. The adjustment assembly 7 has a drive screw 72 formed with a pushing head 71 abutting against the coil spring 6. The drive screw 72 moves along a longitudinal axis of the wrench body 2 when rotated. Rotation of the drive screw 72 in a first direction makes the pushing head 71 compress the coil spring 6 while rotation in a second, reverse direction allows expansion of the coil spring 6. As is understood, changing the spring force will change the preset torque at which the tool release or actuates. It is noted that, the preset torque may be set, in other examples, by rotating either an adjuster sleeve on the handle, an end cap, or a thumb screw.

In the illustrated embodiment, the pawl 23 is substantially cube-shaped and is disposed between a rear surface of the bar 12 and a front surface of the plunger 3. Both the rear surface of the bar 12 and the front surface of the plunger 3 are slightly recessed to receive the cubic pawl 23.

When the torque level is less than a preset torque, the parallel surfaces of the pawl 23 abut against the rear surface of the bar 12 and the front surface of the plunger 3, as shown in FIG. 3 or 4.

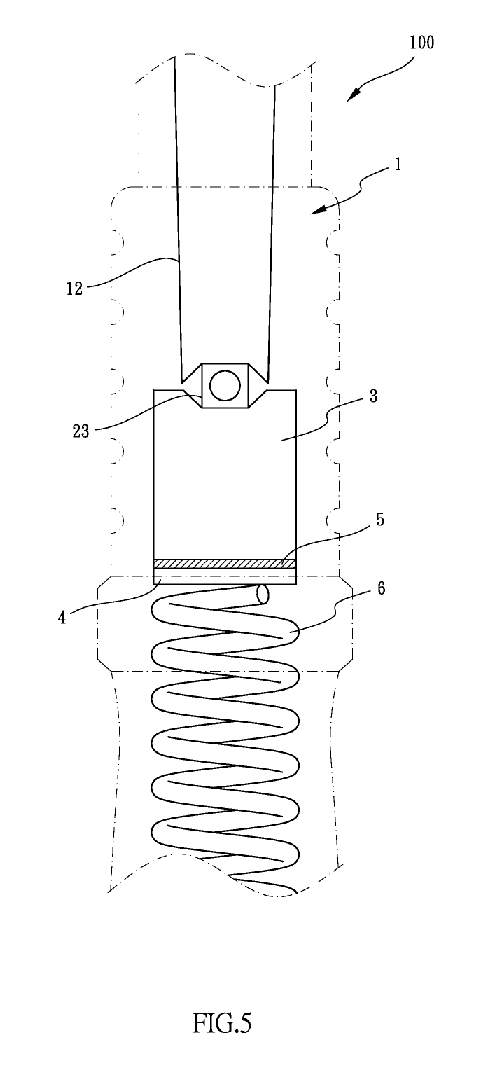

The piezoelectric sensor 5 is interposed in between the plunger 3 and the coil spring 6, as best seen in FIG. 5, for producing an output signal in response to the effective force exerted by the coil spring 8. Preferably, a backing plate 4 is interposed in between the piezoelectric sensor 5 and the coil spring 6.

Referring to FIG. 6, the processor 8 within the wrench body 2 is electrically coupled to the piezoelectric sensor 5 with one end and to the display 9 with the other end. The processor 8 is configured for converting the output signal into an equivalent torque value. The equivalent torque value indicates a preset torque to be applied by the torque wrench to the workpiece 10 and is shown in the display 9 on the wrench body 2, as depicted in FIG. 1. As will be understood, application of a torque greater than the preset torque to the workpiece 10 causes the wrench head 1 to pivot relative to the wrench body 2 about the pivot pin 13.

Referring back to FIG. 5, the piezoelectric sensor 5 is substantially flat in shape. To mate with the sensor 5, the plunger 3 has a rear planar surface attached to a front planar surface of the piezoelectric sensor 5. And the backing plate 4 has a front planar surface attached to the rear planar surface of the piezoelectric sensor 5. Unlike other types of pressure sensors, the piezoelectric sensor 5 employed in this present invention has at least the benefit in that the torque wrench 100 can be made simple and compact.

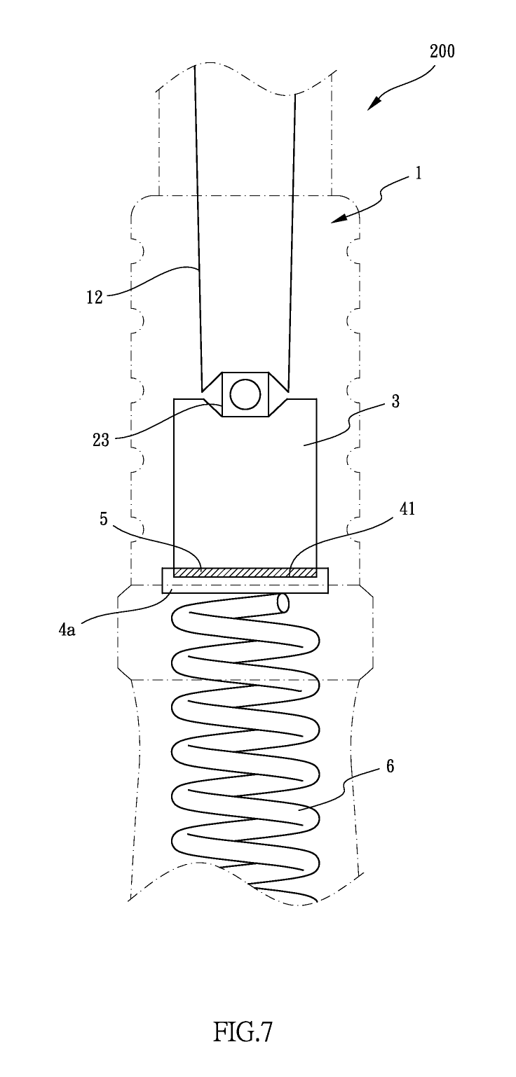

Referring now to FIG. 7, there is shown an alternate embodiment 200. Embodiment 200 is similar to embodiment 100, except that a backing plate 4a is provided in lieu of the aforementioned backing plate 4. The backing plate 4a defines in a front surface a recess 41 to receive and protect the piezoelectric sensor 5 for smooth displacement within the wrench body 2.

As described above, since the spring force of the coil spring 6 is reflected by the piezoelectric sensor 5 in real time, no calibration will be needed to correct the effect of the spring's characteristics and mechanical wear that occurs over time.

What is claimed is:

1. A torque wrench, comprising:
an elongated, tubular wrench body with front and rear ends;
a wrench head having a drive portion constructed to be removably engaged with a workpiece, and a bar extending from the drive portion into the front end of the wrench body; wherein the wrench head and the wrench body are pivotally connected for pivotal movement relative to one another about a pivot joint;
a plunger slidably movable within the wrench body;
a pawl within the wrench body between the bar and the plunger;
a spring disposed within the wrench body and mounted rearwardly of the plunger for urging the plunger and in turn the pawl against a rear end of the bar;
an adjustment assembly in the rear end of the wrench body and operatively connected to the spring to vary an effective force of the spring on the plunger;
a piezoelectric sensor interposed in between the plunger and the spring for producing an output signal in response to the effective force exerted by the spring;
a processor for converting the output signal into an equivalent torque value, the equivalent torque value indicating a preset torque to be applied by the torque wrench to the workpiece; and
a display for displaying the equivalent torque value;
wherein application of a torque greater than the preset torque to the workpiece causes the wrench head to pivot relative to the wrench body about the pivot joint.

2. A torque wrench as recited in claim 1, wherein the plunger has a rear planar surface; and the piezoelectric sensor is substantially flat and has a front planar surface attached to the rear planar surface of the plunger.

3. A torque wrench as recited in claim 2, further comprising a backing plate interposed in between the piezoelectric sensor and the spring.

4. A torque wrench as recited in claim 3, wherein the backing plate has a front planar surface; and the piezoelectric sensor has a rear planar surface attached to the front planar surface of the backing plate.

5. A torque wrench as recited in claim 3, wherein the backing plate defines in a front surface a recess to receive the piezoelectric sensor.

6. A torque wrench as recited in claim 1, wherein the pawl is substantially cube-shaped and is disposed between a rear surface of the bar and a front surface of the plunger; and the rear surface of the bar and the front surface of the plunger are slightly recessed to receive the pawl.

7. A torque wrench as recited in claim 1, wherein the adjustment assembly includes a drive screw formed with a pushing head abutting against the spring.
